(19) United States
(12) Patent Application Publication
(10) Pub. No.: US 2024/0202322 A1
(43) Pub. Date: Jun. 20, 2024

(54) EFFICIENT PROTOTYPING OF ADVERSARIAL ATTACKS AND DEFENSES ON TRANSFER LEARNING SETTINGS

(71) Applicant: Dell Products L.P., Round Rock, TX (US)

(72) Inventors: Pablo Nascimento da Silva, Niterói (BR); Hugo De Oliveira Barbalho, Rio de Janeiro (BR); Roberto Nery Stelling Neto, Rio de Janeiro (BR)

(73) Assignee: Dell Products L.P., Round Rock, TX (US)

(21) Appl. No.: 18/067,501

(22) Filed: Dec. 16, 2022

(51) Int. Cl. G06F 21/55

(52) U.S. Cl. CPC G06F 21/55

(57) ABSTRACT

Techniques are disclosed for providing a framework for fast prototyping attacks and defenses on transfer learning settings. For example, a system can include at least one processing device including a processor coupled to a memory, the at least one processing device being configured to perform the following steps: defining a set of evaluation metrics, each evaluation metric configured to test responses by a machine learning model when applying a given defense among a set of defenses against a set of adversarial inputs generated for the model; selecting one or more defenses from the set of defenses based on the evaluation metrics; and generating a secured model based on incorporating the selected defenses into the model.

### FIELD

Example embodiments generally relate to addressing security vulnerabilities in pre-trained machine learning models. More particularly, at least some embodiments relate to systems, hardware, software, computer-readable media, and methods for the use of adversarial attacks and defenses on pre-trained machine learning models to identify and resolve security vulnerabilities.

### BACKGROUND

Transfer learning methods have mainly been employed to alleviate data availability and the necessity of computational resources to train deep learning models. The idea is that many different pre-trained models are available for a large variety of tasks. These pre-trained models are publicly available and are well-known by the machine learning community. This issue may cause security problems for the final model that leverages transfer learning since it is easier to figure out attacks for well-known models.

### BRIEF SUMMARY

Techniques are disclosed for providing a framework for fast prototyping attacks and defenses on transfer learning settings.

In one embodiment, a system can include at least one processing device including a processor coupled to a memory, the at least one processing device being configured to perform the following steps: defining a set of evaluation metrics, each evaluation metric configured to test responses by a machine learning model when applying a given defense among a set of defenses against a set of adversarial inputs generated for the model; selecting one or more defenses from the set of defenses based on the evaluation metrics; and generating a secured model based on incorporating the selected defenses into the model.

In some embodiments, the selecting one or more defenses further includes minimizing the evaluation metric for the given defense. In addition, the evaluation metrics can include accuracy, similarity measures, or F-measures. In addition, the processor can be further configured to modify the selected defense based on the evaluation metric that applied the given defense to the model. In addition, the model can be a tuned model trained using transfer learning. In addition, the secured model can be a tuned model trained using transfer learning. For example, the secured model can be tuned using transfer learning based on the model. In addition, the model or the secured model can be a deep neural network (DNN). In addition, the processor can be further configured to construct a configuration for applying a set of attacks and the set of defenses to the model, the configuration specifying at least one of: a trained model, an optimizer, a set of evaluators, the set of defenses, the set of attacks, and a given transfer learning procedure. In addition, the processor can be further configured to visualize at least one of: the adversarial inputs, predictions before and after applying each adversarial input, and an accuracy of the model or the secured model.

Other example embodiments include, without limitation, apparatus, systems, methods, and computer program products comprising processor-readable storage media.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

To easily identify the discussion of any particular element or act, the most significant digit or digits in a reference number refer to the figure number in which that element is first introduced.

In the drawings:

FIG. 1A shows aspects of an adversarial Fast Gradient Sign Method attack, in accordance with illustrative embodiments.

FIG. 1B shows aspects of an example equation for the adversarial attack of FIG. 1A, in accordance with illustrative embodiments.

FIG. 2A shows aspects of an adversarial mimicking attack, in accordance with illustrative embodiments.

FIG. 2B shows aspects of an optimization problem for the adversarial attack of FIG. 2A, in accordance with illustrative embodiments.

FIG. 2C shows aspects of an optimization equation for the adversarial attack of FIG. 2A, in accordance with illustrative embodiments.

FIG. 3 shows aspects of a model deployment, in accordance with illustrative embodiments.

FIG. 4 shows aspects of a model deployment, in accordance with illustrative embodiments.

FIG. 5 shows aspects of an architecture for a configuration module, in accordance with illustrative embodiments.

FIG. 6 shows aspects of an example architecture for an evaluation module, in accordance with illustrative embodiments.

FIG. 7 shows aspects of an example visualization, in accordance with illustrative embodiments.

FIG. 8 shows a flowchart of an example method, in accordance with illustrative embodiments.

FIG. 9 shows aspects of a computing device or a computing system in accordance with illustrative embodiments.

### DETAILED DESCRIPTION

Example embodiments generally relate to addressing security vulnerabilities in pre-trained machine learning models. More particularly, at least some embodiments relate to systems, hardware, software, computer-readable media, and methods for the use of adversarial attacks and defenses on pre-trained machine learning models to identify and resolve security vulnerabilities.

The present systems and methods generally provide a framework for fast prototyping attacks and defenses on transfer learning settings. The present prototyping framework allows practitioners to test machine learning (ML) models against popular adversarial attacks, implement more recent attacks and defenses, and provide methods for testing defenses (or combinations of defenses) against attacks. Advantageously, the present prototyping techniques make the process of protecting the model more straightforward, thereby allowing the deployment of more secure models and ultimately reducing risk for the company.

The present framework advantageously provides fast prototyping of adversarial attacks and defenses for transfer learning models. Example embodiments generally provide a plug-and-play fast framework for prototyping adversarial attack and defense algorithms in transfer learning settings.

### A. INTRODUCTION

Deep structured learning, or deep learning, refers to ML techniques that leverage, for example, artificial neural networks along with representation learning. One consideration around deployment of deep learning models is making the model secure against adversarial attacks. This task is difficult to perform since there are many attacks available nowadays, making it difficult to evaluate the effectiveness or correctness of defenses to protect the machine learning model. Disclosed herein is a framework that allows for the fast evaluation of deep learning models trained with transfer learning techniques against attacks. The present prototyping techniques address the following challenges, discussed in further detail below:
1. The risk of deploying an insecure machine learning model to production without proper testing against adversarial attacks
2. Agile testing new attacks and defenses algorithms, their combinations, and evaluate their robustness in transfer learning settings.

### A.1. Overview

Deep learning models usually require enormous amounts of data and computational resources for training. Transfer learning services and methods help solve the problem of lack of data and computational resources. Many services are being offered for fine-tuning pre-trained models using transfer learning methods available from multiple service providers. However, transfer learning's centralized nature makes it an attractive and vulnerable target for attackers since the pre-trained models are usually publicly available or easily accessible.

Nowadays, many pre-trained models, also sometimes referred to as teacher models, are hosted and maintained on popular platforms, such as Azure, Amazon Web Services (AWS), Google Cloud, and GitHub, and access to these models is publicly available. So, since the highly tuned centralized model is publicly available, an attacker could explore that characteristic to create adversarial examples to fool the model, thus creating security problems. Evaluations have been performed of many models available at the cloud provider's machine learning platforms, with the conclusion that there exist relevant vulnerabilities when using publicly image classification models and transfer learning. Such evaluations of original pre-trained models have generally been discussed in Wang, Yao, Viswanath, et al., With Great Training Comes Great Vulnerability: Practical Attacks against Transfer Learning, 27th USENIX Security Symposium, pp. 1281-1297 (2018) (herein, Wang), the contents of which are incorporated by reference herein in their entirety for all purposes.

Adversarial attacks are general topics of interest for study, with many different attacks available and many defenses against the attacks also available. However, applying such methods in a transfer learning environment is still underexplored, with few implemented methods. As a result, it remains difficult for practitioners and researchers to test models trained with transfer learning techniques before deploying the models to a production or live environment. This could potentially lead to problems since vulnerabilities are common to be found.

Accordingly, it is appreciated that artificial intelligence (AI) practitioners would benefit from systems and methods to evaluate if the model trained based on transfer learning techniques is secure before production deployment. It is further appreciated that an unsecured model deployed to production could lead to undesired losses in company reliability with its customers and may incur financial losses.

Example embodiments provide a framework for fast prototyping and evaluating deep learning models trained with transfer learning.

### A.2. Technical Problems

There are multiple problems around securing deep learning models adapted with transfer learning. Particularly, example technical problems include the following, among others:
1. The risk of deploying a potentially unsecure machine learning model to production without properly testing against adversarial attacks, and
2. Agile testing new attack and defense algorithms, their combinations and evaluating the model robustness in transfer learning settings.

### A.2.1. The Risk of Deploying a Potentially Unsecure Machine Learning Model to Production without Properly Testing Against Adversarial Attacks

There is a risk of deploying a machine learning model with security vulnerabilities to a production environment. Adversarial attacks can be quickly produced when the pre-trained model used in the transfer learning training is publicly available. So, a framework for efficient testing of the security of these models is critical to any company deploying machine learning models.

### A.2.2. Agile Testing New Attack and Defense Algorithms, their Combinations, and Evaluating the Model Robustness in Transfer Learning Settings

There are many possible adversarial attacks and defenses that can be applied to secure machine learning models. In fact, in the literature, malicious attacks are being proposed faster than methods for defending from these attacks. So, a framework for evaluating the robustness of transfer learning methods is beneficial. Also, systems and methods for fast implementation and testing of transfer learning defenses are helpful to have available.

### B. CONTEXT FOR SOME EXAMPLE EMBODIMENTS

This section presents context to understand example embodiments. Section B.1 gives an overview of transfer learning, adversarial attacks are presented in section B.2, and section B.3 describes model deployment technology.

### B.1. Transfer Learning

Deep Neural Networks (DNNs) have been widely and successfully employed in various applications, such as image classification, speech recognition, and image segmentation. Training a deep neural network model is both time-consuming and data-intensive. In many applications, these characteristics often make the training of a model from scratch impractical. In these cases, transfer learning provides an approach to overcome these issues.

Transfer learning refers to a ML research area specialized in building useful ML models for a task by reusing a model from a similar but distinct task for the same task, but with different data distribution. In practice, generally, a handful of well-tuned and intricate centralized models (e.g., teacher models) that are pre-trained with large datasets are shared on public platforms. Then, individual users use those models and further customize them to create accurate models, at lower training costs, for specific tasks (e.g., student models). A common approach to performing transfer learning in deep learning is using the pre-trained model as a starting point and fine-tuning the model for a specific task until it achieves a good accuracy using only very small and limited training data.

### B.1.1. Security Concerns on Transfer Learning Models

Transfer learning's centralized nature makes it an attractive and vulnerable target for attackers. Nowadays, many teacher models are hosted and maintained on popular platforms, such as Azure, AWS, Google Cloud, and GitHub, and access to these models is publicly available. So, since the highly tuned centralized model is publicly available, an attacker could explore that characteristic to create adversarial examples to fool the model, thus creating security problems.

### B.1.2. Attacks on Transfer Learning

The attacks can be divided into two categories:
Targeted attacks: focus on modifying the classification output for a given input of the neural network to a specific output. E.g., predict an image of a cat as being a dog. Another example is when an attacker changes the prediction of his face to gain access to a given device.
Untargeted attacks: aim to change the classification for a given input to any class different from the original one. E.g., Disturbing any application that leverages neural networks.

Attacks can also be classified according to the access of their internal information:
White-box attacks: assume the attacker has full access to the internals of the deep neural network. E.g., the attacker knows the weights and architecture of a neural network.
Black-box attacks: assume the attacker has no access to the internals of the target deep neural network, but the attacker can query the target DNN to obtain information.

### B.2. Adversarial Attacks

This section presents two types of adversarial attacks that can be applied to machine learning models trained with transfer learning.

### B.2.1. FGSM Attack

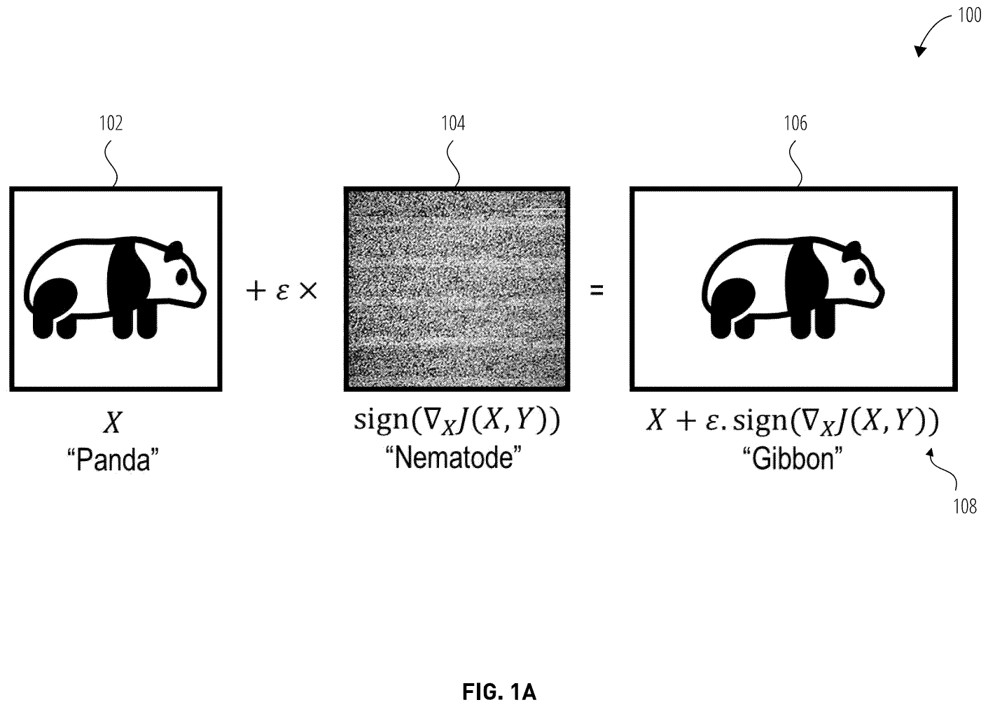

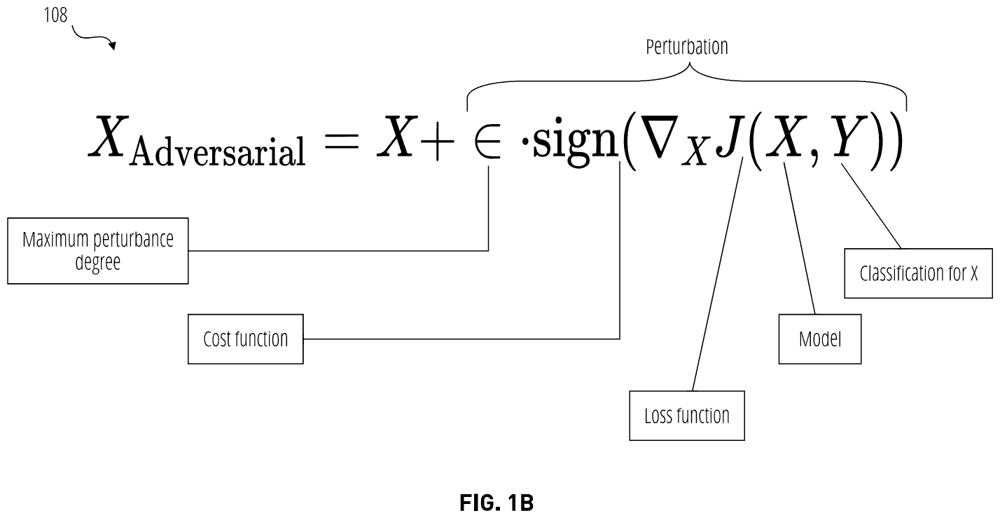

FIG. 1A shows an example adversarial Fast Gradient Sign Method (FGSM) attack 100, in accordance with illustrative embodiments. FGSM uses the gradients of the neural network 104 to create an adversarial example 106. In particular, for an input image 102, FGSM uses the gradients of the loss (J) with respect to the input image to build an adversarial example using, for example, equation 108. Further discussion regarding FGSM can be found in Papernot, McDaniel, Swami, et al., Crafting Adversarial Input Sequences for Recurrent Neural Networks, IEEE Military Commc'ns Conference (MILCOM), pp. 49-54 (2016), the contents of which are incorporated by reference herein in their entirety for all purposes.

For example in the input image 102, the model might correctly classify the image as a “panda” with a particular confidence level, such as 57.7%. FGSM may construct noise 104, which the model might classify as a “nematode” with 8.2% confidence, for example. When the noise is added to the input image to construct the adversarial example 106, the model now incorrectly classifies the adversarial example as a “gibbon,” for example with 99.3% confidence.

FIG. 1B shows example equation 108 for an FGSM attack, in accordance with illustrative embodiments. With reference to FIG. 1A and FIG. 1B, FGSM adds noise 104 to the input image 102 (X) in the direction of the gradient of the cost function (sign(∇_{X}J(X, Y))) with respect to the data (Y). The noise is scaled by a small multiplier ε. The adversarial example 106 can then fool the model, as shown in FIG. 1A.

The FGSM attack generally uses the gradients of the neural network to create an adversarial sample. The overall goal is to fool the model to misclassify the image as any class different from the original one. The equation 108 shows how the gradient is used in this case. Given the model X, the data Y, and a loss function J, the gradient ∇_{X} of the loss J is computed with respect to the input X. This gradient indicates in which direction each pixel of the image should be changed to maximize the loss—that is, to make the classification X different from the data Y. To avoid a large perturbation, only the sign of the gradient is taken into consideration and is multiplied by a maximum perturbance degree e. The purpose in avoiding a large perturbation is that otherwise the change may be perceptible by a human. Thus, the aim of the attack may be to make the perturbation sufficiently large to fool the model X, but not so large as to be perceptible by a human, since the human would then be able to perceive that an attack had been made.

### B.2.2. Mimicking Attack

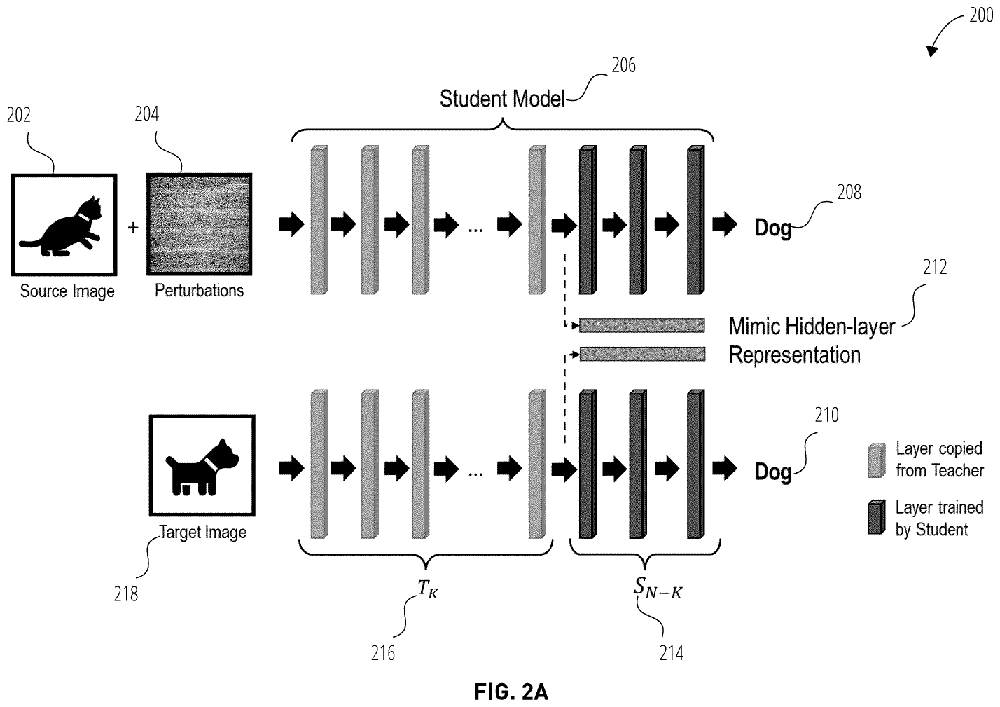

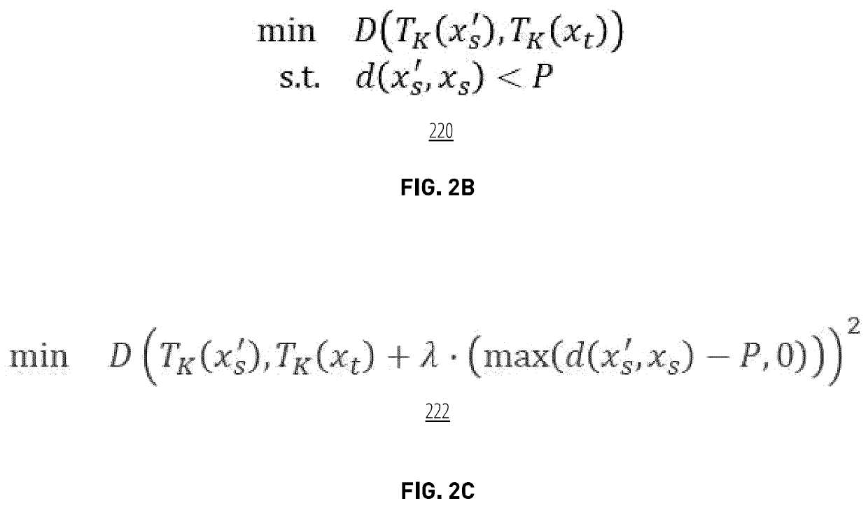

FIG. 2A shows an example adversarial mimicking attack 200, in accordance with illustrative embodiments. Unlike the FGSM attack, the mimicking attack was designed to be an attack on transfer learning. In particular, a mimicking attack presumes white-box access to a teacher model T and black-box access to a student model S. In a mimicking attack, the attacker knows that S was trained using T as a teacher and which layers were frozen during the student training. Recall that, in transfer learning, student models customize deep layers of a teacher DNN model to a related task or same task but with a different domain.

The mimicking attack recognizes that, in feedforward networks, each layer can only observe what is passed on from the previous layer. So, suppose our adversarial sample's (perturbed image) internal representation at layer K perfectly matches the target image's internal representation at layer K. In that case, it must be misclassified into the same label as the target image, regardless of the weights of any layers that follow K. Further discussion of the mimicking attack can be found in Wang.

FIG. 2A shows an example mimicking attack in which the attacker aims to fool the student model 206 DNN to classify 208 a cat image (source image 202) as if it were a dog (target image 218).

FIG. 2B shows an example optimization problem 220, in accordance with illustrative embodiments. With reference to FIG. 2A, to fool the student model 206, the attacker produces a perturbation 204 in the source image 202 to mimic 212 the output 214, 210 from the teacher model of the K-th hidden layer 216. More particularly, FIG. 2B shows that this perturbation is computed by solving the illustrated optimization problem.

The optimization problem 220 minimizes dissimilarity D(⋅) between the two outputs of the K-th hidden-layer, under a constraint to limit perturbation within a budget P. In some embodiments, to compute D(⋅), the L₂ distance can be used. In further embodiments, to compute d(⋅), the DSSIM metric can be used. The optimization problem generally reflects the recognition that humans are sensitive to structural changes in an image, which strongly correlates with their subjective evaluation of image quality. To infer structural changes, DSSIM captures patterns in pixel intensities, especially among neighboring pixels.

FIG. 2C shows an example optimization equation 222, in accordance with illustrative embodiments. With reference to FIG. 2B and FIG. 2C, to solve the optimization problem 220, the penalty method helps reformulate the optimization as shown in equation 222, where X is the penalty coefficient that controls the tightness of the privacy budget constraint. In some embodiments, the optimization equation 222 can be solved using the Adadelta optimizer implemented in Pytorch.

### B.3. Model Deployment

Many different techniques are available to perform optimization in machine learning. For example, AutoML tools can be used to tune the hyperparameters or even the architecture of the deep learning model.

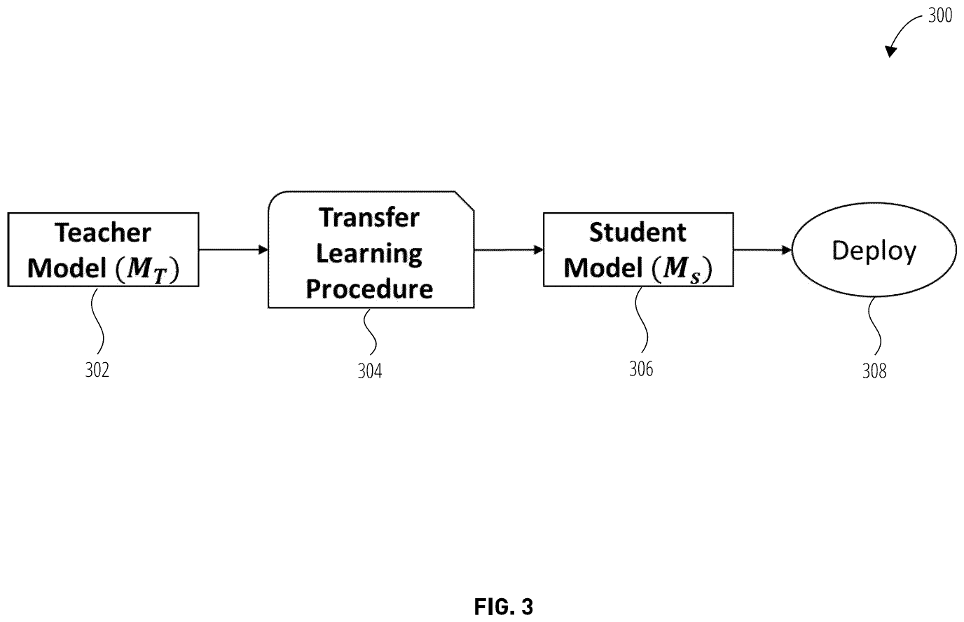

FIG. 3 shows an example model deployment 300, in accordance with illustrative embodiments. The pre-trained teacher model 302 is first trained using a transfer learning technique 304. Subsequently, a tuned student model 306 is generated and deployed 308 to the production environment.

### C. FURTHER ASPECTS OF SOME EXAMPLE EMBODIMENTS

The present prototyping techniques are configured to go one step beyond mere tuning as described in section B.3. For example, the present systems and methods support testing, analysis, fast prototyping, and optimization of defenses for adversarial attacks, which are all unavailable in conventional AutoML tools. Advantageously, the present prototyping framework provides a type of risk assessment; docking the method to the deployment of the model allows production models to be more secure (as discussed further in section C.2.1).

### C.2. Prototyping Framework

To deploy a secure deep learning model, the practitioner should evaluate the model against various adversarial attacks to confirm its robustness. Also, the best defense for the developed model should be chosen or developed after this initial evaluation. So, fast prototyping new defenses against adversarial attacks, combining defenses, and automatically selecting the correct defense for a given model is an important task.

Disclosed herein is a simulation framework that leverages training and evaluation of deep learning models, trained with transfer learning, against adversarial attacks. The present systems and methods can also be used to fast prototype the final model to be deployed in the production environment.

The present prototyping framework provides mechanisms for fast prototyping of novel defenses faster and effortlessly since the developer only extends the classes to create novel features/defenses. Also, the present prototyping framework allows implementation of methods for automatically evaluating robustness of the models by intelligently defining the proper protection or combination of defenses against a list of attacks for a given model.

### C.2.1. Framework Overview

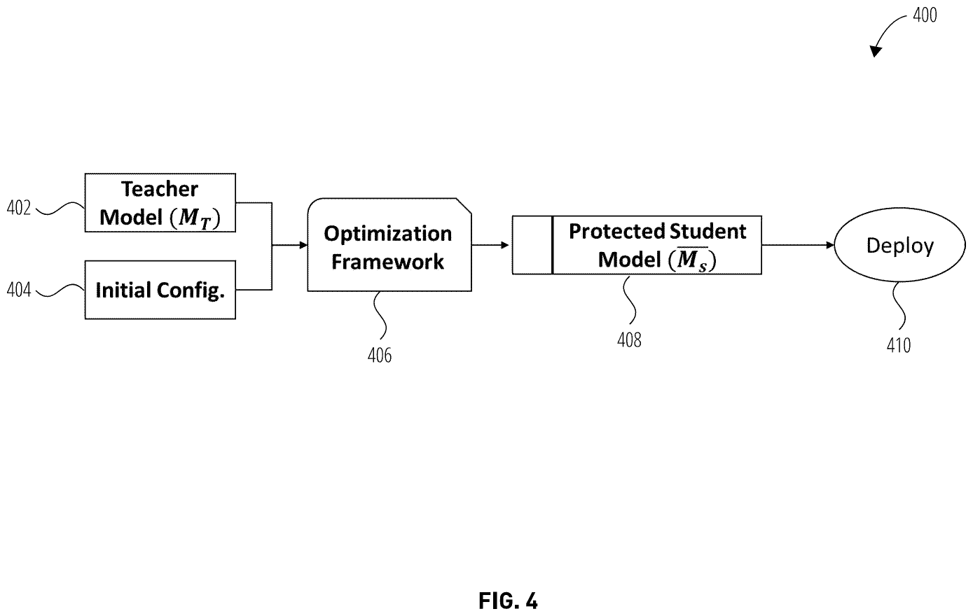

FIG. 4 shows an example model deployment 400, in accordance with illustrative embodiments. This section provides a general overview of the present prototyping framework. The present prototyping framework 406 is configured to act as a form of intermediate stage between the transfer learning procedure and deployment of the final model 408. The framework receives as input the teacher model 402 (M_{T}), e.g., an original pre-trained model, and a configuration file via an initial configuration 404. In example embodiments, the configuration file contains information about the transfer learning procedure that the framework will execute, along with information about the model's vulnerabilities. Example vulnerability information can include the attacks, defenses, and evaluation metrics to be used to secure the final model. Then, the framework is configured to output a secured student model 408 (M̅ₛ̅), e.g., a fine-tuned model by transfer learning with the proper defenses applied. The secured student model can then be deployed 410 into a production environment.

### C.2.1. Framework at Work

This section provides further details around the present transfer learning framework's modules along with its inputs, outputs, and actions.

Example embodiments of the present prototyping framework can be conceptually divided into the following modules:
a. Configuration module
b. Evaluation module
c. Analysis module

The modules are described in more detail in section C.3.

As shown in FIG. 4, the present optimization framework 406 is configured to leverage a teacher model 402 (M_{T}) and an initial configuration 404 as input. Example embodiments of the initial configuration include a listing of the following:
a. Transfer learning procedure
b. List of attacks
c. List of defenses
d. Evaluation metrics

Given a teacher model 402 (M_{T}) and an initial configuration 404, the present framework 406 configuration module is configured to generate a secured student model (M̅ₛ̅) and a new configuration file, which will be used by the evaluation module to run a series of experiments with combinations of attacks and defenses. The evaluation module then runs its optimizer (O) using the optimization framework 406 to optimize the defenses needed according to a list of evaluators. Finally the evaluation module is configured to produce a secured student model 408 (M̅ₛ̅). To allow for both automatic and human in-the-loop verification, the analysis module is configured to provide tools and methods to visualize the adversarial examples before and after attacks and defenses, the accuracy of the models among other features. The analysis module can be easily extended to add new visualizations, plots and tables with evaluator's performance metrics.

### C.3. Modules

This section describes example modules of the present prototyping framework. Example embodiments of the present prototyping framework include the following modules: (i) configuration module, (ii) evaluation module, and (iii) analysis module.

### C.3.1. Configuration Module

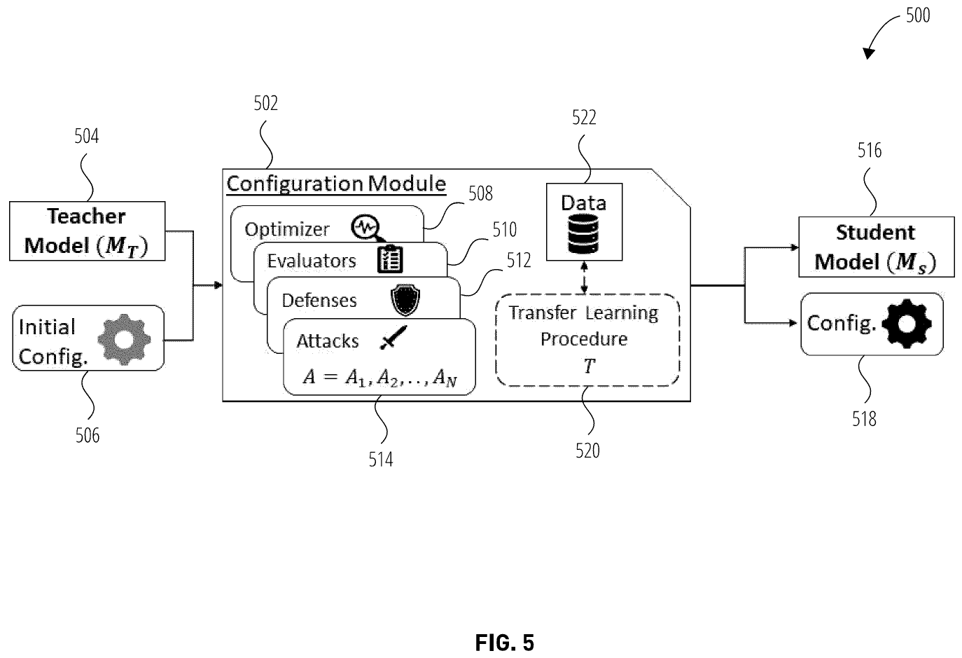

FIG. 5 shows an example architecture 500 for a configuration module 502, in accordance with illustrative embodiments. Particularly, FIG. 5 shows a general overview of example components of the configuration module. The configuration module is generally an initial module responsible for the initial configuration and execution of the transfer learning procedure. In example embodiments, the configuration module is configured for setting the experiment, defining the list of adversarial attacks 514, selecting the defenses 512, the type of the optimizer 508, the list of evaluators 510, and any information needed to perform the transfer learning procedure 520.

The configuration module 502 receives as input the teacher model 504 (M_{T}) and an initial configuration 506. In example embodiments, the initial configuration can include a configuration file. The teacher model comes from a repository of models; as discussed, it represents the pre-trained model used to perform the transfer learning to a new task. In some embodiments the initial configuration file includes information about adapting the teacher model to a new task using transfer learning. For example, the configuration file can list the transfer learning technique, target dataset path 522, loss function, and other configurations for training the student model 516. In further embodiments, the initial configuration also contains information about the optimizer 508, evaluators 510, defenses 512, and attacks 514 used to test the student model. Still further embodiments of the list include both the type and parameters of each component. The output of the configuration module is both a student model (Mₛ) and a configuration file 518. The student model represents the model that will be tested in the following steps of the present framework, and it is the output of the transfer learning procedure.

The transfer learning procedures 520 (T) is shown as part of the configuration module 502, though its execution is optional. For example, if the user should decide to input a student model instead of inputting the teacher model 504 (M_{T}), then the transfer learning procedure is bypassed. Hence, advantageously the configuration module offers two options to the user, either (1) use the present framework to perform transfer learning followed by the security test, or (2) use the present framework to test a model in which transfer learning was applied beforehand (externally from the framework), such as an existing student model.

In example embodiments, internally the configuration module 502 is configured for defining the experiment's configuration and executing some pre-processing on the components passed in the initial configuration file to get them ready for execution in the next module, e.g., the evaluation module. The configuration module is further configured to adapt the input model, e.g., the teacher model 504 (M_{T}), to a new task or domain by applying the transfer learning technique (T) as defined in the initial configuration file. E.g., perform transfer learning 520 by freezing K-layers. These steps and configurations can further include receiving the data path, the number of layers used in the transfer learning, and what type of transfer learning to apply, among other steps.

### C.3.2. Evaluation Module

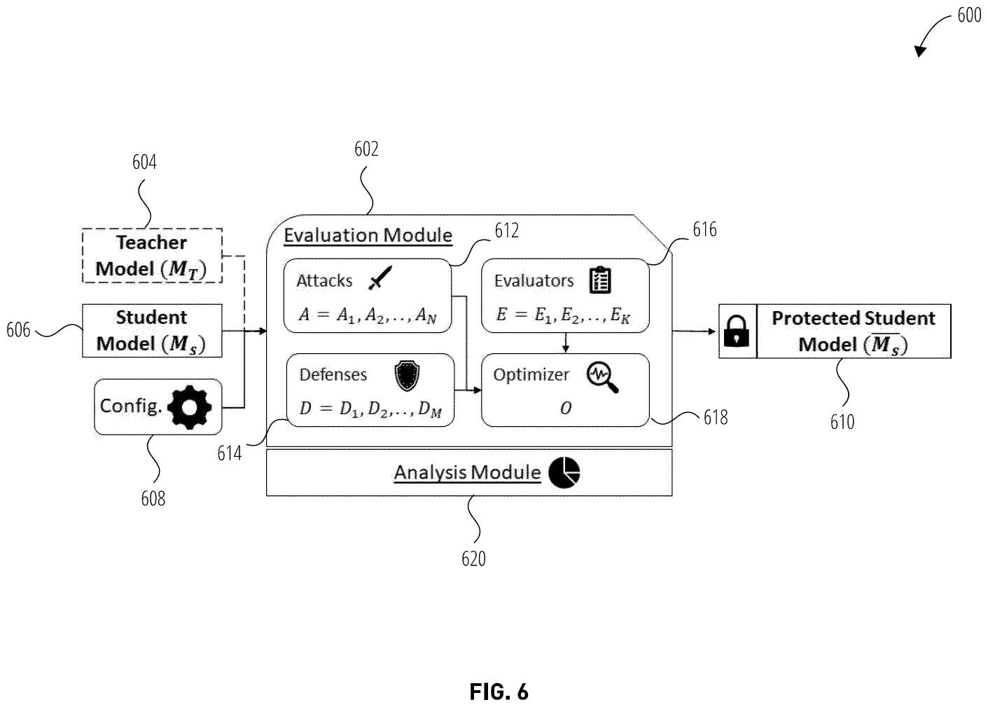

FIG. 6 shows an example architecture 600 for an evaluation module 602, in accordance with illustrative embodiments. In particular, FIG. 6 shows an overview of an example evaluation module and associated components. The evaluation module is configured to execute the experiment with many combinations of attacks and defenses as defined in the configuration module. The evaluation module is also configured for loading the models and saving the results in the appropriate directories and formats. The evaluation module is configured to receive the trained teacher model 604 M_{T} (which is optional), the tuned student model 606 Mₛ (trained in the configuration module), and a configuration file 608 (generated in the configuration module). The evaluation module is configured to output the secured student model 610 Mₛ generated by the Optimizer 618.

In example embodiments, internally the evaluation module 602 is configured as follows. Let A=A₁, A₂, . . . , A_{N} represent a list 612 of N adversarial attacks, D=D₁, D₂, . . . , D_{M} represent a list 614 of M defenses, and E=E₁, E₂, . . . , E_{K} represent a list 616 of K evaluators, all of them defined in the configuration module. The evaluation module runs the Optimizer 618 O, optimizing the defenses needed according to the defined evaluators E. An evaluator refers to a piece of code used to define an evaluation metric. Example evaluation metric s can include the accuracy, similarity measures, any F-measures, a user-defined evaluation metric, or the like. The optimizer refers to a method configured to attempt to select the best defenses for the given student model 606 Mₛ according to the list of the evaluators defined by the user. Example optimizers can include genetic algorithms, Bayesian optimization, and the like. It is further appreciated that any optimizer configured to select the defense that minimizes the optimization measure can be used without departing from the scope of the invention. The list of attacks is used to generate the model's inputs, which are tested against the list of defenses according to the list of evaluators. Ultimately, the Optimizer is configured to select the best defense (or set of defenses) that best protect(s) the student model. Accordingly, the output of the evaluation module can be a secured student model 610 (M̅ₛ̅).

### C.3.3. Analysis Module

The analysis module 620 is configured to provide tools and methods to visualize the adversarial examples, predictions before and after the attack, the accuracy of the models, the evaluation metrics defined by the user, and the like. The analysis module is also configured to allow for further extension, allowing the user to programmatically add new visualizations, plots, and tables with evaluators' performance. With reference to FIG. 6, the analysis module is configured to run alongside the evaluation module 602, for example using the files generated in the course of evaluation to generate experiment visualizations.

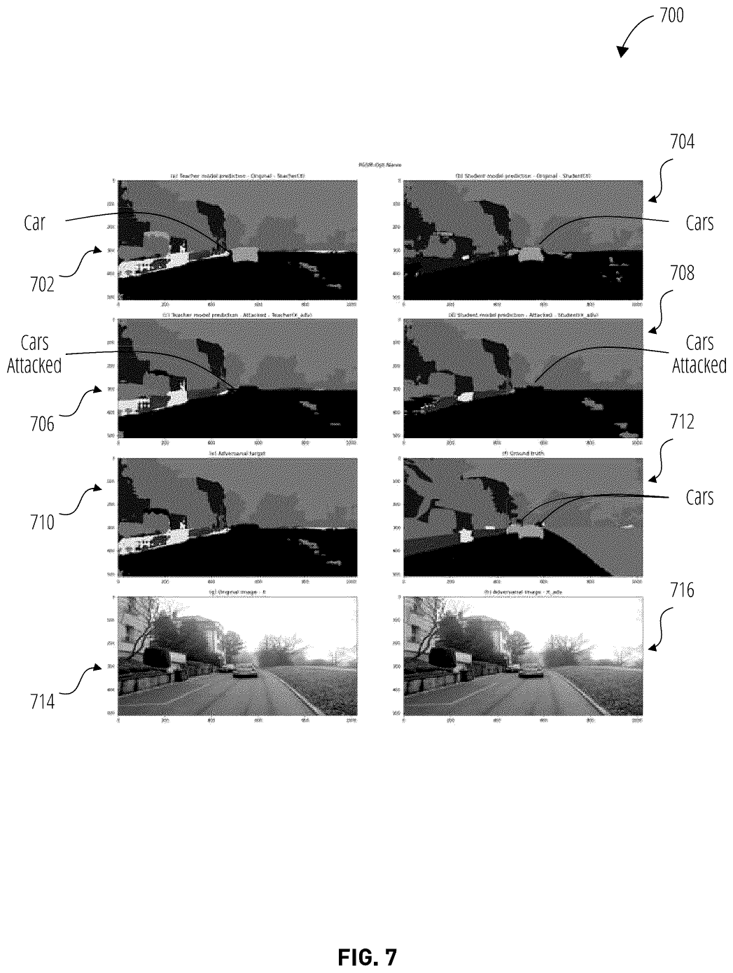

FIG. 7 shows an example visualization 700, in accordance with illustrative embodiments. As discussed in connection with FIG. 6, the analysis module 620 has some visualizations already implemented. Further, as with all components of the present prototyping framework, such visualizations can be easily extended, for example using python code. In particular, FIG. 7 shows example images 702, 704, 706, 708, 710, 712, 714, 716 that can be generated by the analysis module configured to display the result of an adversarial attack to a student and teacher model for a given attacked image 716. Images 702, 704 illustrate example output of the teacher and student model, respectively, for the original image 714. Images 706, 708 illustrate example output of the attacked image 716 for the teacher and student model, respectively. Image 710 illustrates an example adversarial target used by the attack method. Image 712 illustrates an example ground-truth of the prediction. Images 714, 716 illustrate the original image and the attacked image, respectively. The original image 714 is provided in Sakaridis, Dai, Van Gool, Semantic Foggy Scene Understanding with Synthetic Data, Int'l J. of Computer Vision 126.9, pp. 973-992 (2018), the contents of which are incorporated by reference herein in their entirety for all purposes.

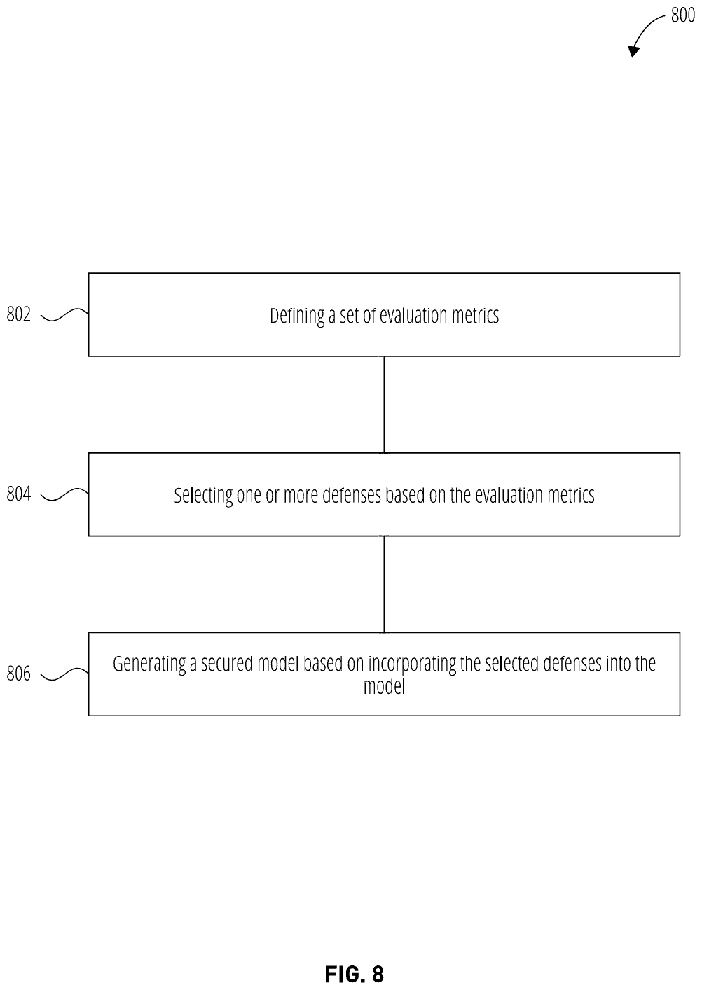

FIG. 8 shows a flowchart of an example method 800, in accordance with illustrative embodiments.

In example embodiments, the method 800 includes defining a set of evaluation metrics (step 802). Each evaluation metric can be configured to test responses by a machine learning model when applying a given defense among a set of defenses against a set of adversarial inputs generated for the model. The evaluation metrics can include, for example, accuracy, similarity measures, or F-measures. In some embodiments, the machine learning model can be a trained model, such as a teacher model. In alternative embodiments, the machine learning model can be a tuned model that is trained using transfer learning. For example, the tuned model can be a student model. In some embodiments, the evaluation metrics are applied using one or more evaluators.

In example embodiments, the method 800 includes selecting one or more defenses from the set of defenses based on the evaluation metrics (step 804). In some embodiments, the method 800 further includes modifying the selected defense based on the evaluation metric that applied the given defense to the model. In some embodiments, the defenses are selected using one or more optimizers configured to select the defenses using the evaluation metrics. For example, the defenses can be selected so as to minimize the evaluation metric for the given defense. In some embodiments, genetic algorithms or Bayesian optimization can be used for an optimization method, though any appropriate optimization strategy can be used without departing from the scope of the invention.

In some embodiments, the method 800 includes constructing a configuration for applying a set of attacks and the set of defenses to the model. In further embodiments, the configuration can specify at least one of: a trained model, an optimizer, a set of evaluators, the set of defenses, the set of attacks, and a given transfer learning procedure.

In example embodiments, the method 800 includes generating a secured model based on incorporating the selected defenses into the model (step 806). In some embodiments, the secured model can be a tuned model that is trained using transfer learning, such as a student model. In some embodiments, the secured model can be generated using a generator configured to incorporate the selected defenses into the model.

In some embodiments, the method 800 includes visualizing at least one of: the adversarial inputs, predictions before and after applying each adversarial input, and an accuracy of the model or the secured model. In some embodiments, the visualizations can be received from an analysis module.

While the various steps in the example method 800 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 800 that any of the disclosed steps, processes, operations, methods, and/or any portion of any of these, may be performed in response to, as a result of, and/or, based upon, the performance of any preceding steps, process(es), methods, and/or, operations. Correspondingly, performance of one or more steps, processes, for example, may be a predicate or trigger to subsequent performance of one or more additional steps, processes, operations, and/or methods. Thus, for example, the various steps or processes that may make up a method may be linked together or otherwise associated with each other by way of relations such as the examples just noted. Finally, and while it is not required, the individual steps or processes that make up the various example methods disclosed herein are, in some embodiments, performed in the specific sequence recited in those examples. In other embodiments, the individual steps or processes that make up a disclosed method may be performed in a sequence other than the specific sequence recited.

At least portions of the present prototyping system 400 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories, and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 400. For example, containers can be used to implement respective processing devices providing compute and/or storage services of a cloud-based system. Again, containers may be used in combination with other virtualization infrastructure such as virtual machines implemented using a hypervisor.

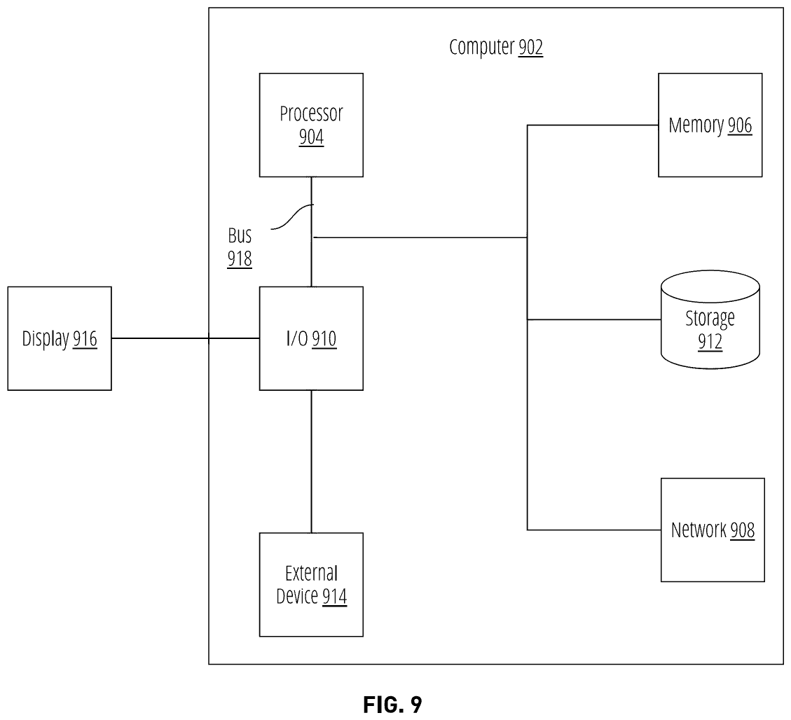

Illustrative embodiments of processing platforms will now be described in greater detail with reference to FIG. 9. Although described in the context of system 400, these platforms may also be used to implement at least portions of other information processing systems in other embodiments.

FIG. 9 shows an example computing device or a computing system, in accordance with illustrative embodiments. The computer 902 is shown in the form of a general-purpose computing device. Components of the computer may include, but are not limited to, one or more processors or processing units 904, a memory 906, a network interface 908, and a bus 918 that communicatively couples various system components including the system memory and the network interface to the processor.

The bus 918 represents one or more of any of several types of bus structures, including a memory bus or memory controller, a peripheral bus, an accelerated graphics port, and a processor or local bus using any of a variety of bus architectures. Example architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 902 typically includes a variety of computer-readable media. Such media may be any available media that is accessible by the computer system, and such media includes both volatile and non-volatile media, removable and non-removable media.

The memory 906 may include computer system readable media in the form of volatile memory, such as random-access memory (RAM) and/or cache memory. The computer system may further include other removable/non-removable, volatile/non-volatile computer system storage media. By way of example only, the storage system 912 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 918 by one or more data media interfaces. As has been depicted and described above in connection with FIGS. 1-8, the memory may include at least one computer program product having a set (e.g., at least one) of program modules that are configured to carry out the functions of the embodiments as described herein.

The computer 902 may also include a program/utility, having a set (at least one) of program modules, which may be stored in the memory 906 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 902 may also communicate with one or more external device 914 such as a keyboard, a pointing device, a display 916, etc.; one or more devices that enable a user to interact with the computer system; and/or any devices (e.g., network card, modem, mobile hotspot, etc.) that enable the computer system to communicate with one or more other computing devices. Such communication may occur via the input/output (I/O) interfaces 910. Still yet, the computer system may communicate with one or more networks such as a local area network (LAN), a general wide area network (WAN), and/or a public network (e.g., the Internet) via the network adapter 908. As depicted, the network adapter communicates with the other components of the computer system via the bus 918. It should be understood that although not shown, other hardware and/or software components could be used in conjunction with the computer system. Examples include but are not limited to microcode, device drivers, redundant processing units, external disk drive arrays, Redundant Array of Independent Disk (RAID) systems, tape drives, data archival storage systems, etc.

### D. FURTHER DISCUSSION

Embodiments of the invention, such as the examples disclosed herein, may be beneficial in a variety of respects. For example, and as is apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

As disclosed herein, example embodiments may provide various useful features and advantages. For example, embodiments may provide a prototyping framework configured to allow practitioners to test ML models against popular adversarial attacks, implement more recent attacks and defenses, and provide methods for testing defenses (or combinations of defenses) against attacks. The present framework advantageously provides fast prototyping of adversarial attacks and defenses for transfer learning models. Particularly, the present prototyping techniques make the process of protecting the model more straightforward, thereby allowing the deployment of more secure models and ultimately reducing risk for the company.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

Specific embodiments have been described with reference to the accompanying figures. In the above description, numerous details have been set forth as examples. It will be understood by those skilled in the art that one or more embodiments may be practiced without these specific details and that numerous variations or modifications may be possible without departing from the scope of the invention. Certain details known to those of ordinary skill in the art have been omitted to avoid obscuring the description.

In the above description of the figures, any component described with regard to a figure, in various embodiments of the invention, may be equivalent to one or more like-named components described with regard to any other figure. For brevity, descriptions of these components have not be repeated with regard to each figure. Thus, each and every embodiment of the components of each figure is incorporated by reference and assumed to be optionally present within every other figure having one or more like-named components. Additionally, in accordance with various embodiments, any description of the components of a figure is to be interpreted as an optional embodiment, which may be implemented in addition to, in conjunction with, or in place of the embodiments described with regard to a corresponding like-named component in any other figure.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the invention should be limited only by the appended claims.

What is claimed is:

1. A system comprising:
at least one processing device including a processor coupled to a memory;
the at least one processing device being configured to implement the following steps:
defining a set of evaluation metrics, each evaluation metric configured to test responses by a machine learning model when applying a given defense among a set of defenses against a set of adversarial inputs generated for the model;
selecting one or more defenses from the set of defenses based on the evaluation metrics; and
generating a secured model based on incorporating the selected defenses into the model.

2. The system of claim 1, wherein the selecting one or more defenses further comprises minimizing the evaluation metric for the given defense.

3. The system of claim 1, wherein the evaluation metrics comprise accuracy, similarity measures, or F-measures.

4. The system of claim 1, wherein the processor is further configured to implement:
modifying the selected defense based on the evaluation metric that applied the given defense to the model.

5. The system of claim 1, wherein the model is a tuned model trained using transfer learning.

6. The system of claim 1, wherein the secured model is a tuned model trained using transfer learning.

7. The system of claim 6, wherein the secured model is tuned using transfer learning based on the model.

8. The system of claim 1, wherein the model or the secured model is a deep neural network (DNN).

9. The system of claim 1, wherein the processor is further configured to implement:
constructing a configuration for applying a set of attacks and the set of defenses to the model, the configuration specifying at least one of: a trained model, an optimizer, a set of evaluators, the set of defenses, the set of attacks, and a given transfer learning procedure.

10. The system of claim 1, wherein the processor is further configured to implement:
visualizing at least one of: the adversarial inputs, predictions before and after applying each adversarial input, and an accuracy of the model or the secured model.

11. A method comprising:
defining a set of evaluation metrics, each evaluation metric configured to test responses by a machine learning model when applying a given defense among a set of defenses against a set of adversarial inputs generated for the model;
selecting one or more defenses from the set of defenses based on the evaluation metrics; and
generating a secured model based on incorporating the selected defenses into the model.

12. The method of claim 11, wherein the selecting one or more defenses further comprises minimizing the evaluation metric for the given defense.

13. The method of claim 11, wherein the evaluation metrics comprise accuracy, similarity measures, or F-measures.

14. The method of claim 11, further comprising modifying the selected defense based on the evaluation metric that applied the given defense to the model.

15. The method of claim 11, wherein the model is a tuned model trained using transfer learning.

16. The method of claim 11, wherein the secured model is a tuned model trained using transfer learning.

17. The method of claim 16, wherein the secured model is tuned using transfer learning based on the model.

18. The method of claim 11, further comprising constructing a configuration for applying a set of attacks and the set of defenses to the model, the configuration specifying at least one of: a trained model, an optimizer, a set of evaluators, the set of defenses, the set of attacks, and a given transfer learning procedure.

19. The method of claim 11, further comprising visualizing at least one of: the adversarial inputs, predictions before and after applying each adversarial input, and an accuracy of the model or the secured model.

20. A non-transitory processor-readable storage medium having stored thereon program code of one or more software programs, wherein the program code when executed by at least one processing device causes the at least one processing device to perform the following steps:
defining a set of evaluation metrics, each evaluation metric configured to test responses by a machine learning model when applying a given defense among a set of defenses against a set of adversarial inputs generated for the model;
selecting one or more defenses from the set of defenses based on the evaluation metrics; and
generating a secured model based on incorporating the selected defenses into the model.
